(19) United States
(12) Patent Application Publication
(10) Pub. No.: US 2026/0082322 A1
(43) Pub. Date: Mar. 19, 2026

(54) ADAPTIVE SCHEDULING FOR COEXISTING WIRELESS RADIOS

(71) Applicant: Cypress Semiconductor Corporation, San Jose, CA (US)

(72) Inventors: Sandeep Sarma MUNUKUTLA, Bangalore (IN); Raghavendra KENCHARLA, Bangalore (IN)

(73) Assignee: Cypress Semiconductor Corporation, San Jose, CA (US)

(21) Appl. No.: 18/885,007

(22) Filed: Sep. 13, 2024

(51) Int. Cl. H04W 52/02; H04W 72/0446; H04W 72/541; H04W 88/06

(52) U.S. Cl. CPC H04W 52/0216; H04W 72/0446; H04W 72/541; H04W 88/06

(57) ABSTRACT

Methods and systems for adaptive scheduling for coexistence wireless radios. The disclosed method includes, among other things, receiving, from a WLAN sub-system, a first schedule of a WLAN application, determining whether the first schedule of the WLAN application overlaps with a second schedule of a WPAN task for a WPAN sub-system of the wireless device, responsive to determining that there is an overlap, generating a third schedule of the WPAN task that does not overlap with the first schedule of the WLAN application, and causing the WPAN sub-system to modify the second schedule of the WPAN task to the third schedule of the WPAN task based on the WPAN task.

### TECHNICAL FIELD

This disclosure relates to wireless devices and, more specifically, to adaptive scheduling for coexistence wireless radios.

### BACKGROUND

Multiple wireless devices using different communication protocols may share a common wireless medium. For example, Wireless Personal Area Network (WPAN) technologies, including Bluetooth® (BT), Bluetooth® Low Energy (BLE), Zigbee®, infrared, and Wireless Local Area Network (WLAN), including Wi-Fi®, share a common wireless medium in a specific gigahertz (GHz) frequency band.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of an exemplary wireless system including a scheduling management engine for adaptive scheduling for wireless local area network and coexisting radio, in accordance with implementations of the present disclosure.

FIG. 2A is an exemplary diagram of scheduling for wireless local area network and coexisting radio without the scheduling management engine of FIG. 1, in accordance with implementations of the present disclosure.

FIG. 2B is an exemplary diagram of scheduling for wireless local area network and coexisting radio with the scheduling management engine of FIG. 1, in accordance with implementations of the present disclosure.

FIG. 3 depicts a flow diagram of an example method for adaptive scheduling for wireless local area network and coexisting radio, in accordance with implementations of the present disclosure.

FIG. 4 depicts a flow diagram of an example method for adaptive scheduling for wireless local area network and coexisting radio, in accordance with implementations of the present disclosure.

### DETAILED DESCRIPTION

Aspects of the present disclosure relate to adaptive scheduling for coexistence wireless radios. Co-existence refers to when a WLAN sub-system coexist with another wireless technology (e.g., WPAN sub-system), in a shared environment, possibly on a single piece of hardware or within close proximity. Due to the co-existence of the WLAN sub-system and WPAN sub-system, their corresponding radios may interfere with one another when transmitting data on the same channel of a frequency band (e.g., an Industrial, Scientific, and Medical (ISM) frequency band) herein referred to as a shared medium.

Typically, time division multiplexing (TDM) is implemented on WLAN and WPAN sub-systems to manage co-existence. More specifically, TDM refers to a method of dividing the channel utilized by both the WLAN sub-system and WPAN sub-system into time slots and assigning each sub-system (e.g., WLAN and WPAN sub-system) a specific time slot to transmit. This prevents WLAN and WPAN sub-systems from interfering with each other, even if they are operating on the same radio channel. Low passive isolation refers to the amount of isolation between the WLAN and WPAN sub-systems which allows for more efficient use of the channel.

Some WLAN subs-systems incorporate power saving mechanisms, such as Target Wake Time (TWT). TWT facilitates the negotiation of wake-up times between devices, allowing them to coordinate when they need to be active to send or receive data. By minimizing or reducing the time radios spend in active mode, power consumption is reduced, ultimately extending battery life, and improving overall energy efficiency in wireless networks.

TWT provides additional benefits in improving user experience for WLAN applications with predictable characteristics, such as voice over internet protocol (VoIP), internet of things (IoT), video streaming, etc. For example, these WLAN applications typically involve bidirectional traffic which are periodic in nature having specific bandwidth requirements (e.g., a duration of time needed to transmit).

Some WLAN sub-systems, using TWT, negotiates parameters of a time interval during which the WLAN sub-system utilizes the shared medium for communication. The time interval is referred to as a TWT time slot. The negotiated parameters are based on the expected traffic pattern of the WLAN application (e.g., VoIP) and includes a duration of the TWT time slot, a frequency of the TWT time slot, and any other relevant parameters. WLAN sub-system schedules one or more TWT time slots based on the negotiated parameters (e.g., a TWT time slot of 20 ms, every 40 ms). At each scheduled TWT time slot, the WLAN sub-system utilizes the shared medium to transmit or receive data associated with the WLAN application as needed (e.g., VoIP packets, downloading/uploading data, or performing other network-related tasks). After the specific TWT time slot is complete, the WLAN sub-system relinquishes the shared medium. At which point, the WPAN sub-system may utilize the shared medium for WPAN activity. The WPAN activity may refer to a WPAN task with predictable characteristics, such as WPAN scan task, a WPAN connection task, or a WPAN advertisement task. As a result, the wake-up times of the WLAN sub-system coincides with the arrival of expected data packets of the WLAN application thereby reducing the need for constant contention. Additionally, unnecessary wake-ups are avoided resulting in improved channel efficiency and overall network performance. However, WPAN activity on the shared medium during TWT time slots may be deprioritized. Thus, the WPAN sub-system experiences interference, congestion, and ultimately degradation in channel efficiency.

Aspects and embodiments of the present disclosure address these and other limitations of the existing technology by modifying transmission schedules of coexisting wireless sub-systems. For example, a controller of the WLAN sub-system obtains an initial schedule of the WLAN application from the WLAN sub-system and a schedule of the WPAN task from the WPAN sub-system. The actor/controller compares the initial schedule of the WLAN application to the schedule of the WPAN task to determine whether there are any overlap. In response to an overlap, the schedule of the WPAN task may be modified to avoid the schedule of the WLAN application. Otherwise, the schedule of the WLAN application may be modified to avoid the schedule of the WPAN task. Modifying the schedule of the WLAN application or the schedule of the WPAN task involves, for example, modifying a time slot duration and/or a periodicity. Time slot duration refers to a duration of time for each time slot of a plurality of time slots associated with the WLAN application or task. Periodicity refers to a period of time between each time slot of the plurality of time slots.

Aspects of the present disclosure overcome these deficiencies and others by reducing the impact of interference from other wireless devices in a dense environment, thereby reducing re-transmission and improving WPAN performance.

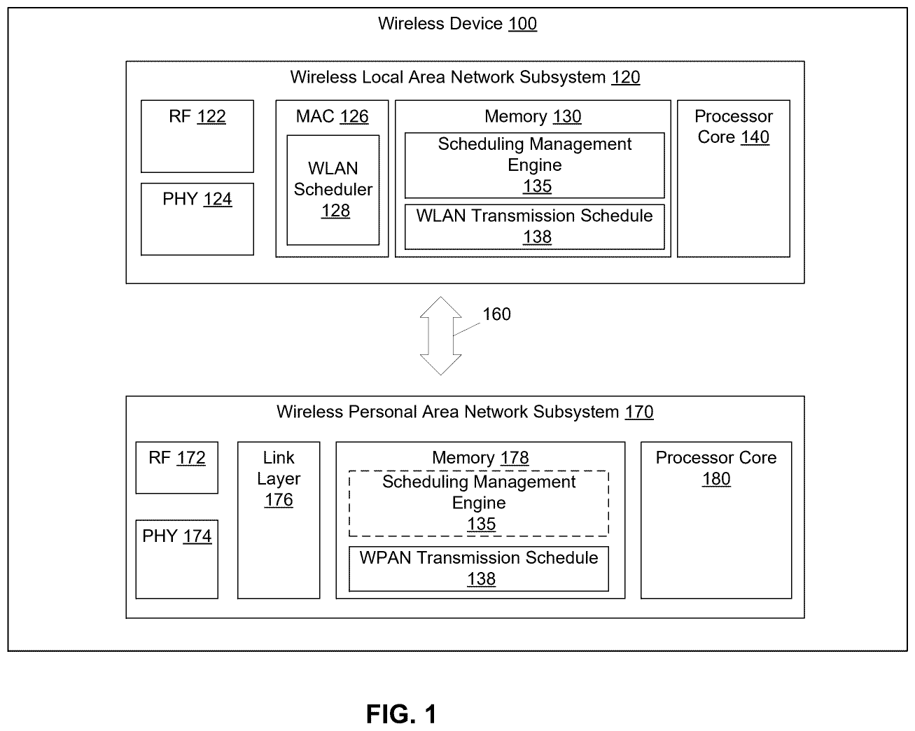

FIG. 1 is a block diagram of an exemplary wireless device 100, in accordance with implementations of the present disclosure. Wireless device 100 may include a WLAN sub-system 120 and a WPAN sub-system 170.

WLAN sub-system 120 includes, but is not limited to, a radio frequency front-end circuitry (RF) 122, a physical layer (PHY) 124, a media access control layer (MAC) 126, a memory 130, and a processor 140.

RF 122 is responsible for handling the radio signals involved in WLAN communication. RF 122 is coupled to one or more antennas of the wireless device 100 which receives and transmits radio signals. RF 122 may further include, but is not limited to, a low-noise amplifier (LNA), a power amplifier, one or more filters, and one or more switches. LNA is used to amplify the weak signals received by the antenna without significantly adding to the noise. Power amplifier increases the power of the signal to be sent out through the antenna, ensuring it is strong enough to reach the intended receiver. The one or more filters selects the appropriate frequency bands, such as 2.4 GHz or 5 GHz. The one or more switches alternate between transmission and reception modes in instances where a single antenna is used for both transmitting and receiving. In some embodiments, RF 122 may be a single component for multiple frequency bands or multiple components for each of the frequency bands.

PHY 124 is configured to transmit and receive radio signals over a frequency band (e.g., 2.4 GHz and/or 5 GHz bands). Additionally, PHY 124 is responsible for modulating data bits into a radio signal that can be transmitted, coordinating channel access with other wireless device (e.g., WLAN sub-systems or WLAN devices), and detecting/correcting errors that may occur during transmission. MAC 126 is responsible for managing and maintaining wireless communications, such as, Wi-Fi®. In particular, MAC 126 encapsulates data into frames with specific MAC addresses for transmission and decapsulation, employs protocol to manage medium access and minimize or reduce data transmission collisions, implements power-saving protocols to manage the energy use of the network interface, and, among other responsibilities, manages fair bandwidth allocation among all connected devices. Processor 140 is responsible for executing instructions stored in memory 130. The instructions, among other things, manages communication protocols, processing signals, coexistence strategies, etc. Memory 130 includes, but is not limited to, one or more volatile memory and/or non-volatile memory used for store instructions, firmware, operational data, etc.

WLAN sub-system 120 may further include a WLAN scheduler 128. The WLAN scheduler 128 may be located in MAC 126. The WLAN scheduler 128 may receive a request to schedule use of the shared medium by the WLAN sub-system 120 for a WLAN application (e.g., a VoIP, IoT, or video streaming). The request may include schedule metadata used to schedule a plurality of time slots (e.g., TWT slots) for the WLAN application (e.g., schedule metadata of the WLAN application). Schedule metadata includes a duration and a periodicity. The schedule metadata of the WLAN application may be used to generate a schedule of the WLAN application. The WLAN scheduler 128 determines whether the schedule of the WLAN application interferes with schedules of other WLAN application (e.g., previously scheduled WLAN application). In particular, the WLAN scheduler 128 queries a WLAN transmission schedule 138 to identify whether any schedule of a previously scheduled WLAN application overlaps with the WLAN application. The WLAN transmission schedule 138 refers to a timetable that includes a schedule of each of the previously scheduled WLAN applications. If the schedule of WLAN application does not overlap with any previously scheduled WLAN applications, the WLAN scheduler 128 utilizes the schedule of the WLAN application generated using the schedule metadata of the WLAN application. Otherwise, the WLAN scheduler 128 indicates that the schedule of the WLAN application generated using the schedule metadata of the WLAN application is unable to be used. Accordingly, based on the WLAN transmission schedule 138, the WLAN sub-system 120 request access to the shared medium for the WLAN application and/or the previously scheduled WLAN applications.

WPAN sub-system 170 includes, but is not limited to, a RF 172, a PHY 174, a link controller 176, a memory 178, and a processor 180. Processor 180 is responsible for executing instructions stored in memory 178. Memory 178 includes, but is not limited to, one or more volatile memory and/or non-volatile memory.

RF 172, similar to RF 122 of the WLAN sub-system 120, is responsible for handling the radio signals involved in WPAN communication (e.g., Bluetooth® (BT), BLE, Zigbee®, Z-Wave®, and the like). In some embodiments, RF 172 is coupled to an antenna of the one or more antennas of the wireless device 100 which receives and transmits radio signals. In some embodiments, RF 172 is coupled to an antenna separate and apart from the one or more antennas of the wireless device 100 coupled to RF 122 of the WLAN sub-system. RF 122 may further include, but is not limited to, a low-noise amplifier (LNA), a power amplifier, one or more filters, and one or more switches. LNA is used to amplify the weak signals received by the antenna without significantly adding to the noise. Power amplifier increases the power of the signal to be sent out through the antenna, ensuring it is strong enough to reach the intended receiver. The one or more filters ensures that the WPAN sub-system 170 operates within its designated frequency band (e.g., 2.4 GHz band) and minimizes or reduces interference from other RF sources. The one or more switches alternate between transmission and reception modes in instances where a single antenna is used for both transmitting and receiving.

PHY 174 is configured to transmit and receive radio signals over a frequency band (e.g., 2.4 GHz) to enable wireless communication between other WPAN sub-systems and/or WLAN sub-systems. PHY 174 uses a variety of modulation schemes to achieve specific data rates and employs various techniques to improve the reliability of the communication, such as error detection and correction, frequency hopping, and time-division duplexing. Link controller 176 implements a link layer of a WPAN protocol stack and is responsible for transmitting and receiving data packets, managing the physical link, and handling errors. Link controller 176 interacts with a link manager, stored in memory 178, used to implement power saving and security aspects of the link layer protocol. Thus, the link manager provides information about the link status and to receive instructions.

WPAN protocol stack includes lower layers implemented by various components of the WPAN sub-system and/or device and higher layers implemented by a host. The lower layers include, for example, the physical layer implemented by PHY 174, and link layer implemented by link controller 176. The higher layers include, for example, a logical link control and adaptation (L2CAP) layer, an attribute protocol (ATT) layer, a generic attribute profile (GATT) layer, a security manager protocol (SMP) layer, and a generic access profile (GAP) layer. L2CAP layer provides services for communication between WPAN sub-systems and/or devices. ATT layer provides a standardized approach to accessing and manipulating data on WPAN sub-systems and/or devices. GATT layer defines a hierarchical structure of attributes, organized into services and characteristics, providing a consistent and organized way to access and manipulate data related to specific WPAN applications. SMP layer safeguards communication between WPAN sub-systems and/or devices by establishing secure connections and protecting data from unauthorized access. GAP layer facilitates basic communication and discovery for sub-systems and/or devices by providing services, common features, and advertising and scanning capabilities.

A WPAN task, such as WPAN advertising, WPAN scan, or WPAN connection may be initiated. During initiation of the WPAN task, the WPAN task may include schedule metadata used to schedule a plurality of time slots for the WPAN task (e.g., schedule metadata of the WPAN task). Similar to above, the schedule metadata of the WPAN task may include time slot duration and periodicity. The WPAN scheduler 178 may assess existing WPAN task(s) to determine when to start the WPAN task on the shared medium. For example, the WPAN scheduler 178 identifies a specific instances which provides the least amount of overlap between the existing WPAN task(s) and the WPAN task. The specific instances may be represented as a time offset from a beginning of the existing WPAN task(s). The schedule metadata of the WPAN task may further include the time offset. Accordingly, after the time offset, the WPAN sub-system 170 may request access to the shared medium to start the WPAN task.

Interface 160 refers to a communication protocol used to facilitate coexistence of the WLAN sub-system 120 and the WPAN sub-system 170, especially in situations where the WLAN sub-system 120 and the WPAN sub-system 170 operate in overlapping frequency band (e.g., 2.4 GHz band), herein referred to as “a shared medium. ” Interface 160, for example, may be a 2-wire serial enhanced coexistence interface (SECI) or 3-wire generic coexistence interface (GCI). Interface 160 serves as communication channels between the WLAN sub-system 120 and the WPAN sub-system 170, allowing them to coordinate their operation. In particular, managing timing of transmissions, power levels, and channel selection.

Existing coexistence strategies stored on memory 130 of the WLAN sub-system 120, when executed by the processor 140, manages the shared medium by using TDM to allocate specific time slots for transmission by the WLAN sub-system 120 and WPAN sub-system 170, ensuring coexistence without interfering with each other. The existing coexistence strategies, when executed by processor 140, causes the WLAN sub-system 120 to send CTS-2-Self frames with an expiration time associated with transmission of a WPAN packet of the WPAN sub-system 170 to itself, allowing the WLAN sub-system 120 to avoid transmitting during that time.

Memory 130 may include a schedule management engine 135. In some embodiments, schedule management engine 135 may be stored on memory 178 and executed by processor 180. In some embodiments, schedule management engine 135 may be stored in other components of wireless device 100 and executed by processor 140 and/or 180. In some embodiments, schedule management engine 135 may be stored externally (i.e., outside the wireless device) and executed by processor 140, 180, and/or an external processor.

In response to receiving, by the WLAN scheduler 128, a request to schedule a WLAN application, the WLAN scheduler 128 provides schedule metadata of the WLAN application to the schedule management engine 135. Schedule management engine 135, when executed by a processor (e.g., processor 140), in response to receiving the schedule metadata of the WLAN application, determines whether there is an active WPAN task. Each time a WPAN task, such as a WPAN task, is initiated on the WPAN sub-system 170, the WPAN schedule 178 provides schedule metadata of the active WPAN task to the schedule management engine 135. Accordingly, if schedule management engine 135 received schedule metadata of a WPAN task, schedule management engine 135 determines that there is an active WPAN task. Otherwise, schedule management engine 135 determines that there is no active WPAN task.

In the event that there is an active WPAN task, schedule management engine 135 determines whether a schedule of the active WPAN task overlaps with a schedule of the WLAN application. In particular, schedule management engine 135 generates the schedule of the WLAN application using the schedule metadata of the WLAN application and generates the schedule of the WPAN task using the schedule metadata of the WPAN task. Accordingly, if at least one time slot of a plurality of time slots of the schedule of the WLAN application overlaps with at least one time slot of a plurality of time slots of the schedule of the WPAN task, schedule management engine 135 determines that there is an overlap.

Responsive to schedule management engine 135 determining that there is an overlap, schedule management engine 135 determines whether the schedule of the WPAN task may be modified to avoid overlapping with the schedule of the WLAN application. WPAN can be determined to be modifiable based on a type of WPAN task (e.g., non-audio related task, such as advertisement, scans, connections, etc., can modifiable). For example, schedule management engine 135 modifies one or more aspect (e.g., time offset, the duration, and/or the periodicity) of the schedule metadata to generate a modified schedule metadata of the WPAN task. The modified schedule metadata of the WPAN task may be used to generate a suggested schedule of the WPAN task that avoids overlapping with the schedule of the WLAN application. Responsive to successfully generating a modified schedule metadata that generates a suggested schedule of the WPAN task that avoids overlapping with the schedule of the WLAN application, the schedule management engine 135 provides the modified schedule metadata to the WPAN sub-system 170 to modify a schedule of the active WPAN task. The WPAN sub-system 170 may determine whether to utilize the modified schedule metadata to avoid interference with the WLAN sub-system 120.

Responsive to unsuccessfully establishing a modified schedule metadata that generates a suggested schedule of the WPAN task that avoids overlapping with the schedule of the WLAN application, the schedule management engine 135 modifies one or more aspect (e.g., the duration and/or the periodicity) of the schedule metadata to generate a modified schedule metadata of the WLAN application. The modified schedule metadata of the WLAN application may be used to generate a suggested schedule of the WLAN application that avoids overlapping with the schedule of the WPAN task.

Responsive to successfully establishing a modified schedule metadata that generates a suggested schedule of the WLAN application that avoids overlapping with the schedule of the WPAN task, the schedule management engine 135 provides the modified schedule metadata to the WLAN sub-system 120 to modify a schedule of the WLAN application. The WLAN sub-system 120 may determine whether to utilize the modified schedule metadata to improve channel efficiency for the WPAN sub-system 170.

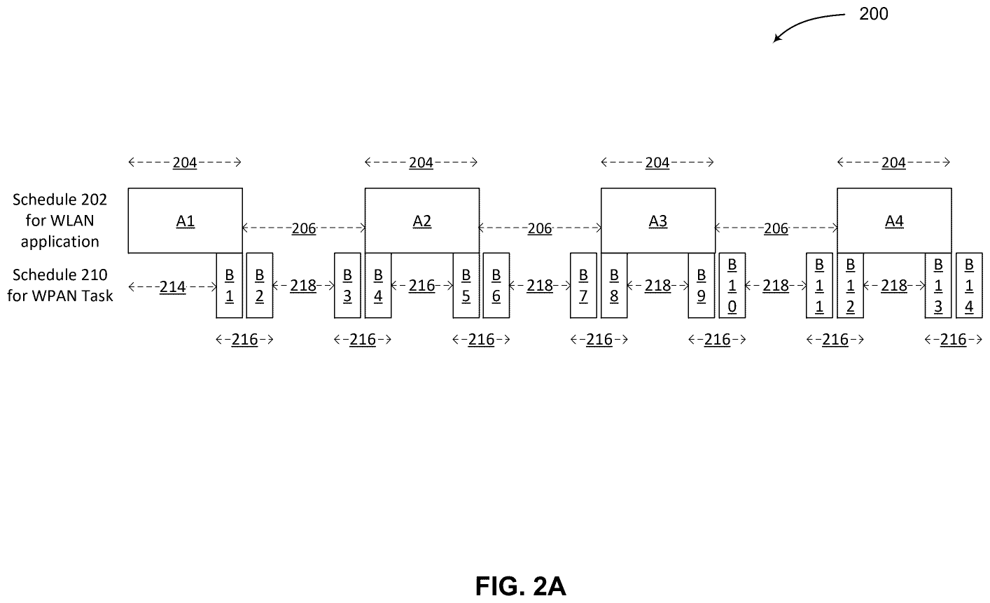

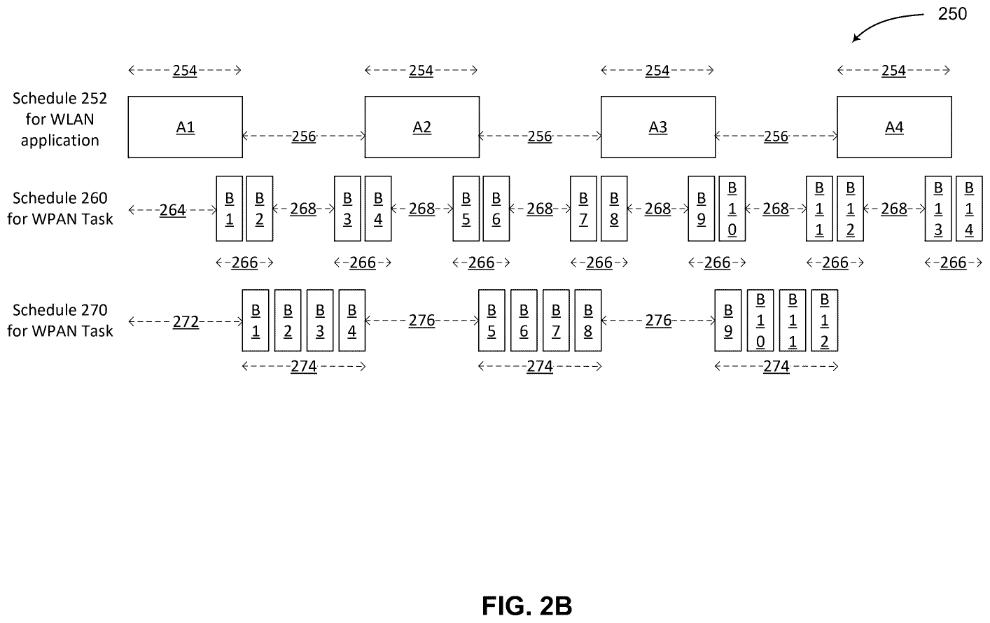

FIG. 2A is an exemplary diagram of scheduling for wireless local area network and coexisting radio without the scheduling management component of FIG. 1, in accordance with implementations of the present disclosure.

A WLAN sub-system, similar to WLAN sub-system 120 of FIG. 1, may request a WLAN scheduler of the WLAN sub-system to schedule a plurality of time slots for the WLAN application represented as schedule 202. During each time slot of the plurality of time slots of schedule 202 one or more packets (e.g., A1-A4) of the WLAN application is transmitted. Schedule 202 is generated using a schedule metadata of the WLAN application which includes duration and periodicity. For example, duration refers to a period of time (e.g., period of time 204) for each time slot and periodicity refers to a period of time (e.g., period of time 206) between time slots.

A WPAN sub-system, similar to WPAN sub-system 170 of FIG. 1, may, in response to initiation of a WPAN task, schedule a plurality of time slots for the WPAN task represented as schedule 210. The plurality of time slots is started at an instance with the least overlap, and during each time slot of the plurality of time slots of schedule 210 one or more packets (e.g., B1-B14) of WPAN task is transmitted. Schedule 210 is generated using schedule metadata of the WPAN task which includes time offset, duration, and periodicity. For example, time offset refers to a period of time (e.g., a period of time 214) from an initial position to an instance with the least overlap, duration refers to a period of time (e.g., period of time 216) for each time slot and periodicity refers to a period of time (e.g., period of time 218) between time slots.

As previously described, the WLAN sub-system has priority to use the shared medium for the WLAN application over the WPAN sub-system for the WPAN task. Accordingly, any overlaps in the use of the shared medium between the schedule 202 for WLAN application and the schedule 210 for WPAN task results in one or more packets of the WPAN task being loss (e.g., B1, B4, B5, B8, B9, B12, and B13).

FIG. 2B is an exemplary diagram of scheduling for wireless local area network and coexisting radio with the scheduling management engine of FIG. 1, in accordance with implementations of the present disclosure.

A WLAN sub-system, similar to WLAN sub-system 120 of FIG. 1, may request a WLAN scheduler of the WLAN sub-system to schedule a plurality of time slots for the WLAN application represented as schedule 252, which is similar to schedule 202. Schedule metadata of the WLAN application used to generate schedule 252 (e.g., schedule metadata of schedule 252) includes a period of time 254 for duration and a period of time 256 for periodicity. Schedule management engine, similar to schedule management engine 135 of FIG. 1, receives the schedule metadata of schedule 252.

A WPAN sub-system, similar to WPAN sub-system 170 of FIG. 1, may, in response to initiation of a WPAN task, schedule a plurality of time slots for the WPAN task represented as schedule 260, which is similar to schedule 210. Schedule metadata of the WPAN task used to generate schedule 260 (e.g., schedule metadata of schedule 260) includes a period of time 264 for time offset, a period of time 266 for duration and a period of time 268 for periodicity. Schedule management engine, in response to initiation of the WPAN task, receives the schedule metadata of schedule 260.

Schedule management engine, using the schedule metadata of schedule 252 and the schedule metadata of schedule 260, determines whether there is an overlap between schedule 252 and schedule 260. Responsive determining that there is an overlap, schedule management engine modifies the schedule metadata of schedule 260 to generate schedule 270 of the WPAN task to avoid overlapping with the schedule 252 for the WLAN application. In particular, schedule management engine modifies the period of time 264 for time offset to a period of time 272, the period of time 266 for duration to a period of time 274, and the period of time 268 for periodicity to a period of time 276. Accordingly, schedule management engine generates a modified schedule metadata which can be used, by the WPAN sub-system, to generate schedule 270 of the WPAN task. Schedule management engine 135 provides the modified schedule metadata to the WPAN sub-system to adjust schedule 260 for the WPAN task to schedule 270 for the WPAN task.

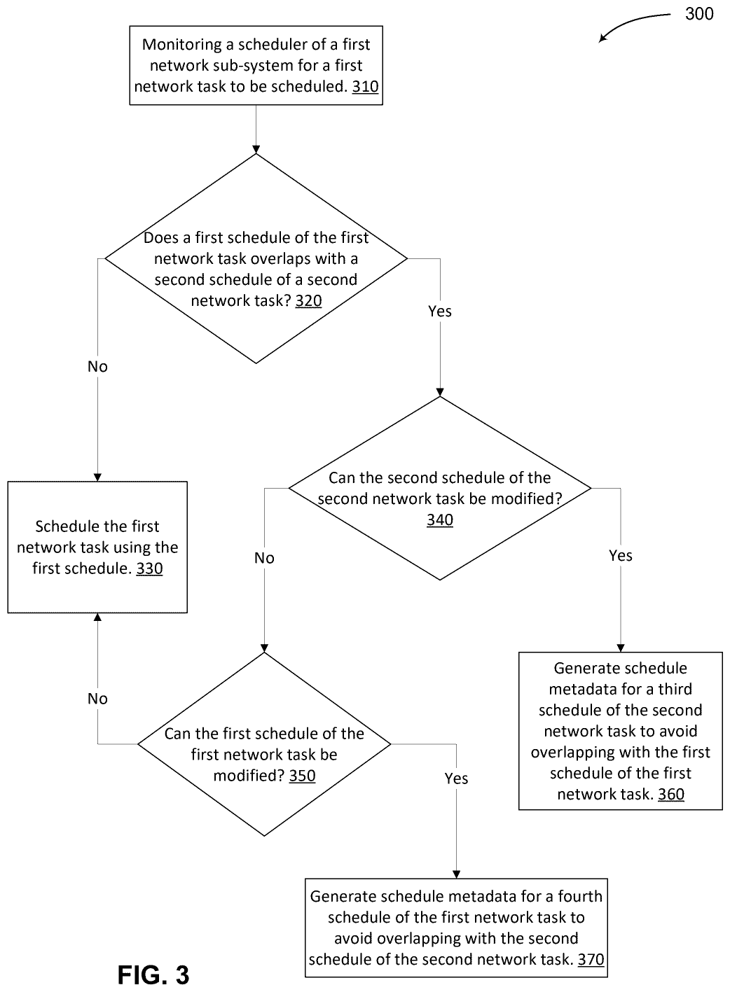

FIG. 3 depicts a flow diagram of an example method 300 for adaptive scheduling for wireless local area network and coexisting radio, in accordance with implementations of the present disclosure. Method 300 can be performed by a processing logic that can include hardware (circuitry, dedicated logic, etc.), software (e.g., instructions run on a processing device), or a combination thereof. In one implementation, some, or all of the operations of method 300 can be performed by one or more components of the WLAN sub-system 120 of FIG. 1. In some embodiments, some, or all of the operations of method 300 can be performed by scheduling management engine 135 of FIG. 1, as described above.

At block 310, the processing logic receives, from a scheduler of a first wireless sub-system (e.g., WLAN sub-system), a first schedule of a first task (e.g., WLAN application). Receiving the first schedule of the first task includes receiving schedule metadata used to generate the first schedule of the first task. As previously described, a scheduler of the first wireless sub-system may receive a request to schedule a first task and provides to the processing logic the schedule metadata of the first task used to generate a first schedule of the first task. The schedule metadata of the first task includes duration and periodicity.

At block 320, the processing logic determines whether the first schedule of the first task overlaps with a second schedule of a second task (e.g., WPAN task). The processing logic generates, based on the schedule metadata of the first task, the first schedule of the first task. The processing logic receives, in response to an initiation of a second task, schedule metadata of the second task for a second wireless sub-system. The schedule metadata of the second task includes time offset, duration, and periodicity. The processing logic generates, based on the schedule metadata of the second task, the second schedule of the second task. Thus, the processing logic compares the first schedule of the first task with the second schedule of the second task to identify any time slots that overlap. As previously described, there is an overlap if at least one time slot of a plurality of time slots of the second schedule of the first task overlaps with at least one time slot of a plurality of time slots of the second schedule of the second task.

Responsive to determining that the first schedule of the first task does not overlap with the second schedule of the second task, at block 330, the processing logic schedules the first task using the first schedule. Otherwise, at block 340, the processing logic determines whether the second schedule of the second task can be modified.

Responsive to determining that the second schedule of the second task can be modified, at block 360, the processing logic generates a third schedule of the second task to avoid overlapping with the first schedule of the first task. In particular, the processing logic modifies the schedule metadata of the second task to generate a modified schedule metadata of the second task. The modified schedule metadata of the second task can be used by the second wireless sub-system to generate the third schedule of the second task that avoids overlapping with the first schedule of the first task. Modifying the schedule metadata of the second task includes modifying the time offset, duration, and/or periodicity. The processing logic may provide the modified schedule metadata to the second wireless sub-system. The second wireless sub-system may decide whether to utilize the third schedule of the second task associated with the modified schedule metadata instead of the second schedule of the second task.

Responsive to determining that the second schedule of the second task cannot be modified, at block 350, the processing logic determines whether the first schedule of the first task can be modified. Responsive to determining that the first schedule of the first task can be modified, at block 370, the processing logic generates a fourth schedule of the first task to avoid overlapping with the second schedule of the second task. In particular, the processing logic modifies the schedule metadata of the first task to generate a modified schedule metadata. Modifying the schedule metadata of the second task includes modifying the time offset, duration, and/or periodicity. The modified schedule metadata may be used by the first wireless sub-system to generate the fourth schedule of the first task that avoids overlapping with the schedule of the second task. The processing logic may provide the modified schedule metadata to the first wireless sub-system. The first wireless sub-system decides on whether to utilize the fourth schedule of the first task associated with the modified schedule metadata instead of the first schedule of the first task.

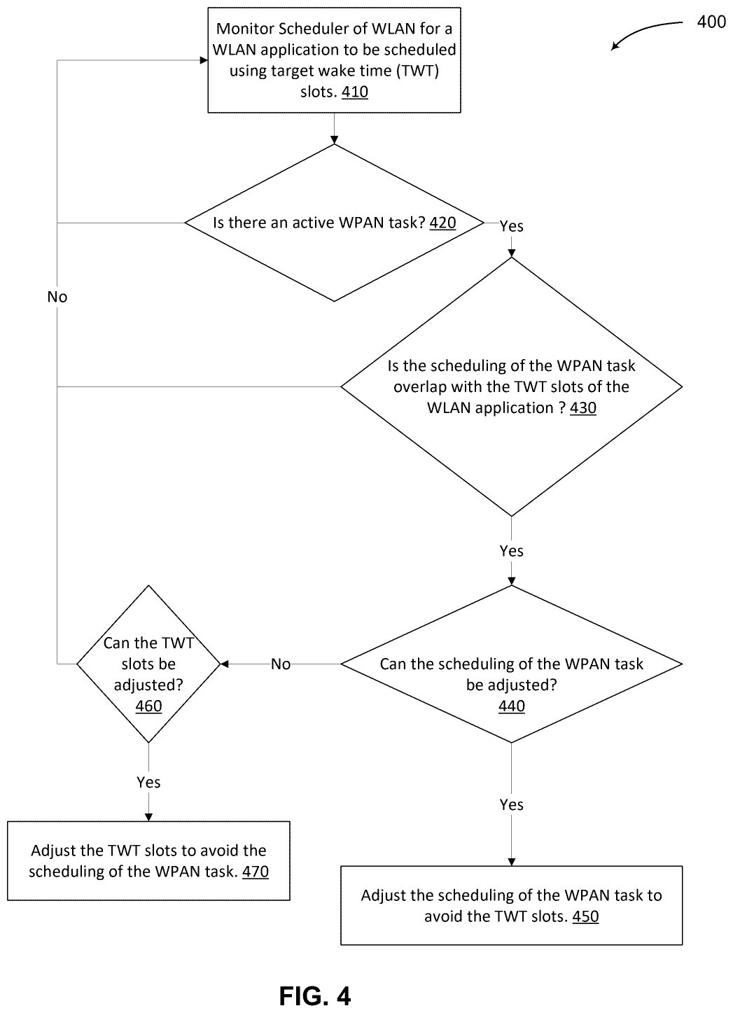

FIG. 4 depicts a flow diagram of an example method 400 for adaptive scheduling for wireless local area network and coexisting radio, in accordance with implementations of the present disclosure. Method 400 can be performed by a processing logic that can include hardware (circuitry, dedicated logic, etc.), software (e.g., instructions run on a processing device), or a combination thereof. In one implementation, some, or all of the operations of method 400 can be performed by one or more components of the WLAN sub-system 120 of FIG. 1. In some embodiments, some, or all of the operations of method 400 can be performed by scheduling management engine 135 of FIG. 1, as described above.

At block 410, the processing logic receives, from a scheduler of WLAN sub-system, a schedule of a WLAN task scheduled generated using target wake time (TWT) time slots. As previously described, TWT facilitates the negotiation of parameters associated with wake-up times of the WLAN sub-system to coordinate when data of the WLAN task is sent and received. As previously described, the negotiated parameters (e.g., schedule metadata) are based on the expected traffic pattern of the WLAN task which includes a duration of the TWT time slot (e.g., duration) and a period of time between each TWT time slot (e.g., periodicity). The negotiated parameters are received from the WLAN sub-system as schedule metadata of the WLAN task which includes the duration and the periodicity.

At block 420, the processing logic determines whether there is an active WPAN task. As previously described, the processing logic may receive, in response to initiation of the WPAN task, schedule metadata of the active WPAN task from the WPAN sub-system. Schedule metadata refers a time offset, a duration, and a periodicity of a plurality of time slots associated with the active WPAN task. The time offset refers to a period of time from an initial position to an instance with the least overlap. Similar to above, duration refers to a duration of a time slot, and periodicity refers to a period of time between time slots. Accordingly, schedule metadata is received from the WPAN sub-system the there is an active WPAN task.

At block 430, the processing logic determines whether the scheduling of the WPAN task overlaps with the scheduling of the WLAN task. For example, the processing logic determines that the scheduling of the WPAN task overlaps with the scheduling of the WLAN task by determining that at least one time slot associated with the scheduling of the WPAN task overlaps with at least one TWT time slot associated with the scheduling of the WLAN task.

At block 440, the processing logic determines whether the scheduling of the WPAN task can be modified. Responsive to determining that the scheduling of the WPAN task can be modified (e.g., non-audio related WPAN task), at block 450, the processing logic modifies the scheduling of the WPAN task to avoid the TWT time slots. As previously described, modifying the scheduling of the WPAN task to avoid the TWT time slots includes modifying an aspect of the schedule metadata of the WPAN task (e.g., time offset, duration, and/or periodicity) to generate a modified scheduled metadata. The modified scheduled metadata is provided to the WPAN sub-system. The WPAN sub-system may utilize the modified scheduled metadata (which represents a suggested schedule of the WPAN task) to modify the scheduling of the WPAN task.

Responsive to determining that the scheduling of the WPAN task cannot be modified (e.g., audio related WPAN task), at block 460, the processing logic determines whether the TWT time slots of the WLAN task can be modified.

Responsive to determining that the TWT time slots of the WLAN task can be modified, at block 470, the processing logic modifies the TWT time slots to avoid the scheduling of the WPAN task. As previously described, modifying the TWT time slots of the WLAN task includes modifying an aspect of the schedule metadata of the WLAN task (e.g., duration, and/or periodicity) to generate a modified scheduled metadata. The modified scheduled metadata is provided to the WLAN sub-system. The WLAN sub-system may utilize the modified scheduled metadata (which represents a suggested schedule of the WLAN task) to modify the scheduling of the WPAN task.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or. ” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving, from a wireless local area network (WLAN) sub-system of a wireless device, a first schedule of a WLAN application, wherein the first schedule of the WLAN application includes a first plurality of time slots for the WLAN application;
determining whether the first schedule of the WLAN application overlaps with a second schedule of a wireless personal area network (WPAN) task for a WPAN sub-system of the wireless device, wherein the second schedule of the WPAN task includes a second plurality of time slots;
responsive to determining that there is an overlap, determining whether the second schedule of the WPAN task can me modified;
responsive to determining that the second schedule of the WPAN task can be modified, generating a third schedule of the WPAN task that does not overlap with the first schedule of the WLAN application; and
in response to generating the third schedule of the WPAN task, causing the WPAN sub-system to modify the second schedule of the WPAN task to the third schedule of the WPAN task based on the WPAN task.

2. The method of claim 1, wherein the third schedule of the WPAN task is generated by modifying at least one of a periodicity or a duration of the second plurality of time slots in the WPAN to avoid the first plurality of time slots.

3. The method of claim 1, wherein the WLAN application is one of an voice over internet protocol (VoIP) application, a video streaming application, or an Internet of Things (IoT) application.

4. The method of claim 1, wherein the WPAN task is one of: a WPAN advertising task, a WPAN scan task, or a WPAN connection task.

5. The method of claim 1, wherein the first schedule of the WLAN is generated using target wake time (TWT).

6. The method of claim 1, further comprising:
responsive to determining that the second schedule of the WPAN task cannot be modified, generating a fourth schedule of the WLAN application that does not overlap with the second schedule of the WPAN task; and
in response to generating the fourth schedule of the WLAN application, causing the WLAN sub-system to modify the first schedule of the WLAN application to the fourth schedule of the WLAN application.

7. The method of claim 6, wherein the fourth schedule of the WLAN application is generated by modifying at least one of a periodicity or a duration of the first plurality of time slots to avoid the second plurality of time slots in the WPAN.

8. A wireless device comprising:
a first wireless sub-system comprising a processor, and
a second wireless sub-system operating on a frequency band with the first wireless sub-system, wherein the processor of the first wireless sub-system is to perform operations comprising:
receiving, from the first wireless sub-system, a first schedule of a first task, wherein the first schedule of the first task includes a first plurality of time slots for the first task;
determining whether the first schedule of the first task overlaps with a second schedule of a second task for the second wireless sub-system, wherein the second schedule of the second task includes a second plurality of time slots for the second task;
responsive to determining that there is an overlap, determining whether the second schedule of the second task can me modified;
responsive to determining that the second schedule of the second task can be modified, generating a third schedule of the second task that does not overlap with the first schedule of the first task; and
in response to generating the third schedule of the second task, causing the second wireless sub-system to modify the second schedule of the second task to the third schedule of the second task.

9. The wireless device of claim 8, wherein the third schedule of the second task is generated by modifying at least one of: a periodicity or a duration of the second plurality of time slots to avoid the first plurality of time slots.

10. The wireless device of claim 8, wherein the first task is one of: voice over internet protocol (VoIP), video streaming, or internet of things (IoT) application.

11. The wireless device of claim 8, wherein the second task is one of: an advertising task, a scan task, or a connection task.

12. The wireless device of claim 8, wherein the first schedule of the first task is generated using target wake time (TWT).

13. The wireless device of claim 8, wherein the processor of the first wireless sub-system is to perform operations further comprising:
responsive to determining that the second schedule of the second task cannot be modified, generating a fourth schedule of the first task that does not overlap with the second schedule of the second task; and
in response to generating the fourth schedule of the first task, causing the first wireless sub-system to modify the first schedule of the first task to the fourth schedule of the first task.

14. The wireless device of claim 13, wherein the fourth schedule of the first task is generated by modifying at least one of a periodicity or a duration of the first plurality of time slots to avoid the second plurality of time slots.

15. A wireless local area network (WLAN) sub-system, comprising:
a processor; and
a memory comprising a schedule management engine, wherein the schedule management engine when executed by the processor is to perform operations comprising:
receiving a first schedule of a WLAN application, wherein the first schedule of the WLAN application includes a first plurality of time slots for the WLAN application;
determining whether the first schedule of the WLAN application overlaps with a second schedule of a wireless personal area network (WPAN) task for a WPAN sub-system, wherein the second schedule of the WPAN task includes a second plurality of time slots;
responsive to determining that there is an overlap, determining whether the second schedule of the WPAN task can me modified;
responsive to determining that the second schedule of the WPAN task can be modified, generating a third schedule of the WPAN task that does not overlap with the first schedule of the WLAN application; and
in response to generating the third schedule of the WPAN task, causing the WPAN sub-system to modify the second schedule of the WPAN task to the third schedule of the WPAN task.

16. The WLAN sub-system of claim 15, wherein the third schedule of the WPAN task is generated by modifying at least one of a periodicity or a duration of the second plurality of time slots to avoid the first plurality of time slots.

17. The WLAN sub-system of claim 15, wherein the WLAN application is one of: voice over internet protocol (VoIP), video streaming, or internet of things (IoT) application.

18. The WLAN sub-system of claim 15, wherein the WPAN task is one of: a WPAN advertising task, a WPAN scan task, or a WPAN connection task.

19. The WLAN sub-system of claim 15, wherein the schedule management engine when executed by the processor is to perform operations further comprising:
responsive to determining that the second schedule of the WPAN task cannot be modified, generating a fourth schedule of the WLAN application that does not overlap with the second schedule of the WPAN task; and
in response to generating the fourth schedule of the WLAN application, causing the WLAN sub-system to modify the first schedule of the WLAN application to the fourth schedule of the WLAN application.

20. The WLAN sub-system of claim 19, wherein the fourth schedule of the WLAN application is generated by modifying at least one of: a periodicity or a duration of the first plurality of time slots to avoid the second plurality of time slots.
